(19) United States
(12) Patent Application Publication
(10) Pub. No.: US 2026/0061234 A1
(43) Pub. Date: Mar. 5, 2026

(54) BATTERY STRUCTURE AND FLIGHT VEHICLE INCLUDING THE SAME

(71) Applicant: HYUNDAI MOBIS CO., LTD., Seoul (KR)

(72) Inventor: Seung Hoon HAN, Yongin-si (KR)

(73) Assignee: HYUNDAI MOBIS CO., LTD., Seoul (KR)

(21) Appl. No.: 19/209,070

(22) Filed: May 15, 2025

(30) Foreign Application Priority Data
Sep. 3, 2024 (KR) 10-2024-0119235

(51) Int. Cl. A62C 3/08; A62C 3/16; A62C 35/68; A62C 99/00; H01M 10/42; H01M 50/233; H01M 50/249; H01M 50/342

(52) U.S. Cl. CPC A62C 3/08; A62C 3/16; A62C 35/68; A62C 99/0018; H01M 10/4228; H01M 50/233; H01M 50/249; H01M 50/3425; H01M 2200/20; H01M 2220/20

(57) ABSTRACT

A battery structure includes a plurality of battery packs, and a fluid storage part disposed at one side of the plurality of battery packs and configured to store an electrically insulative fire extinguishing fluid. Each of the plurality of battery packs includes a plurality of battery cells including electrodes and separators, a casing part defining an internal space configured to accommodate the battery cells, and a piping line connected to one end to the casing part and at another end to the fluid storage part, the piping line having a flow path configured to deliver the fire extinguishing fluid to the casing part.

### CROSS-REFERENCE TO RELATED APPLICATION

This application claims the benefit under 35 U.S.C. § 119(a) of Korean Patent Application No. 10-2024-0119235 filed on Sep. 3, 2024 in the Korean Intellectual Property Office, the entire disclosure of which is incorporated herein by reference for all purposes.

### BACKGROUND

### 1. Field

The present disclosure relates to a battery structure and a flight vehicle including the same, and more particularly, to a battery structure capable of extinguishing a fire in the event of thermal runaway, and a flight vehicle including the same.

### 2. Discussion of Related Art

A casing of a battery pack, in which a plurality of batteries are mounted, needs to be durable enough to withstand thermal runaway in the battery even in the event of the thermal runaway. Meanwhile, in the event of thermal runaway in the battery in the battery pack, the casing may be deformed by a rapid increase in pressure in the casing. The deformation of the casing causes a situation in which thermal energy generated by gases and fire in the casing is rapidly discharged to the outside.

Therefore, there is a need for a means capable of quickly extinguishing a fire occurring in the casing in the event of thermal runaway in the battery in the battery pack. In particular, in case that the battery pack is mounted in an aerial mobility vehicle such as advanced air mobility (AAM), there is a special need for rapid extinguishment of a fire caused by thermal runaway before an emergency landing of the aerial mobility vehicle in consideration of great damage that may be caused by a crash of the aerial mobility vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure has been made in an effort to provide a means capable of quickly extinguishing a fire caused by thermal runaway in the event of the thermal runaway in a battery structure including a battery pack.

In one general aspect, a battery structure includes: a plurality of battery packs; and a fluid storage part disposed at one side of the plurality of battery packs and configured to store an electrically insulative fire extinguishing fluid. Each of the plurality of battery packs includes: a plurality of battery cells including electrodes and separators; a casing part defining an internal space configured to accommodate the battery cells; and a piping line connected at one end to the casing part and at another end to the fluid storage part, the piping line having a flow path configured to deliver the fire extinguishing fluid to the casing part.

At least some of piping lines of the plurality of battery packs may be arranged in parallel with one another.

The battery structure may further include: a valve member disposed in the piping line and configured to open or close the flow path in the piping line. Each of the plurality of battery packs further includes: a gas detection member disposed in the casing part and configured to detect a gas within the casing part; and a control member operatively connected to the gas detection member and configured to operate the valve member in response to a signal from the gas detection member.

Each of the plurality of battery packs may further include a level detection member disposed in the casing part and configured to detect a level of the fire extinguishing fluid in the casing part, and the control member may be configured to receive a signal related to the level of the fire extinguishing fluid from the level detection member.

The battery cell may include an electrolyte, and the gas detection member may be configured to detect a gas generated by vaporization of the electrolyte.

Each of the plurality of battery packs may further include a fracturable member disposed at one side of the piping line, and the fracturable member may be configured to close the piping line and to fracture when a predetermined pressure or higher is applied.

The fracturable member may include a notch region having a smaller thickness than other portions of the fracturable member.

The fire extinguishing fluid may include or be composed of a fluoroketone-based material.

The fluid storage part may be disposed above the plurality of battery packs.

Each of the plurality of battery packs may further include: a cover part coupled to one side of the casing part; and sealing members provided between the casing part and the cover part. The sealing members may include first and second sealing members provided separately from each other. A direction in which the casing part and the cover part face each other with the first sealing member interposed therebetween, and a direction in which the casing part and the cover part face each other with the second sealing member interposed therebetween, may intersect each other.

The casing part may have a first recessed region having a recessed shape, the cover part may have a second recessed region having a recessed shape, the first sealing member may be seated in the first recessed region, and the second sealing member may be seated in the second recessed region.

The cover part may have a flat surface in a region where the first sealing member is in contact with the cover part, and the casing part may have a flat surface in a region where the second sealing member is in contact with the casing part.

A flight vehicle may include the battery structure disclosed above.

In another general aspect, a method for extinguishing fire in a battery structure including a plurality of battery packs and a fluid storage part configured to store an electrically insulative fire extinguishing fluid includes: detecting, by a gas detection member provided in a casing part of a battery pack, a gas generated in the casing part; transmitting a detection signal from the gas detection member to a control member; operating, by the control member, a valve member provided in a piping line connected between the fluid storage part and the battery pack; and injecting the fire extinguishing fluid from the fluid storage part into the casing part of the battery pack through the piping line.

The gas detection member may detect a gas generated by vaporization of an electrolyte included in a battery cell of the battery pack.

The control member may further receive a signal related to a level of the fire extinguishing fluid detected by a level detection member provided in the casing part.

The fire extinguishing fluid may include a fluoroketone-based material that is electrically insulative and non-corrosive.

In order to achieve the above-mentioned object, another aspect of the present disclosure provides a flight vehicle including the battery structure.

According to the present disclosure, it is possible to quickly extinguish a fire caused by thermal runaway in the event of the thermal runaway in the battery structure including the battery pack.

Other features and aspects will be apparent from the following detailed description, the drawings, and the claims.

### BRIEF DESCRIPTION OF THE DRAWINGS

FIG. 1 is a schematic view of a battery structure according to an embodiment of the present disclosure.

FIG. 2 is a schematic view of a battery structure according to another embodiment of the present disclosure.

FIG. 3 is a view illustrating an example of a fracturable member provided in the battery structure of the present disclosure in a state made before the fracturable member is fractured.

FIG. 4 is a view illustrating an example of the fracturable member provided in the battery structure of the present disclosure in a state made after the fracturable member is fractured.

FIG. 5 is an enlarged schematic view illustrating a partial region of a battery pack in the battery structure according to the present disclosure.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

Hereinafter, a battery structure according to the present disclosure will be described.

### Battery Structure

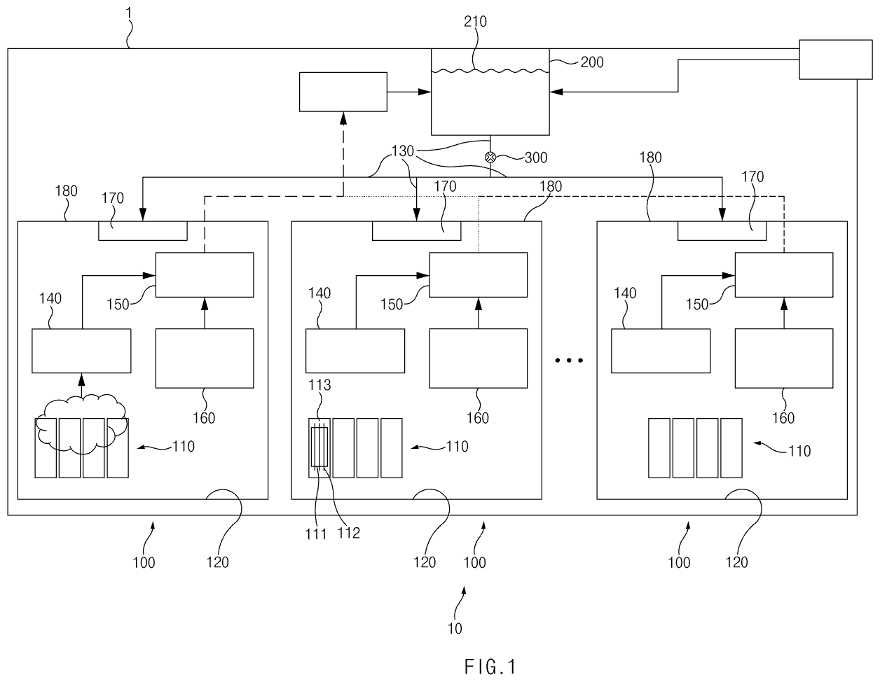

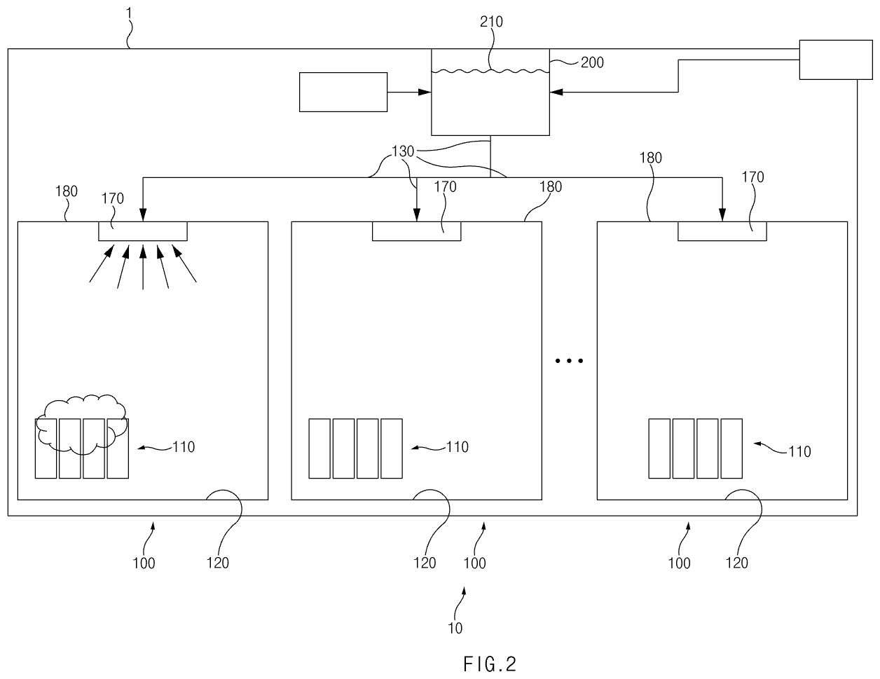

FIG. 1 is a schematic view of a battery structure according to an embodiment of the present disclosure, and FIG. 2 is a schematic view of a battery structure according to another embodiment of the present disclosure.

With reference to FIGS. 1 and 2, a battery structure 10 according to the present disclosure may include a plurality of battery packs 100, and a fluid storage part 200 provided at one side of the battery packs 100 and configured to store an electrically insulative fire extinguishing fluid 210 therein. The fluid storage part 200 may be configured to extinguish a fire when the fire occurs in the event of thermal runaway in at least some of the plurality of battery packs 100. More specifically, according to the present disclosure, in the event of thermal runaway in some of the plurality of battery packs 100, the fire extinguishing fluid 210 in the fluid storage part 200 may be supplied to the battery pack 100, such that the fire may be extinguished. For example, the fire extinguishing fluid 210 may include or be made of a fluoroketone-based material.

Meanwhile, the plurality of battery packs 100 may each include battery cells 110 including electrodes 111 and separators 112, a casing part 120 having an internal space configured to accommodate the battery cells 110, and a piping line 130 connected to one side of the casing part 120, having the other side connected to the fluid storage part 200, and having therein a flow path. The above-mentioned fire extinguishing fluid 210 may be introduced through the piping line 130 into the internal space of the casing part 120 provided in the battery pack 100.

Meanwhile, according to the present disclosure, at least some of the piping lines 130 provided in the plurality of battery packs 100 may be disposed in parallel with one another. This is to i) supply the fire extinguishing fluid 210 only to the battery pack 100 in which thermal runaway occurs in the event of the thermal runaway in some of the plurality of battery packs 100 and ii) cope with thermal runaway in the plurality of battery packs 100 even in the state in which only the single fluid storage part 200 is provided. For example, as illustrated in FIGS. 1 and 2, the piping lines 130 provided in the plurality of battery packs 100 may share a connection part connected to the fluid storage part 200, and the piping lines 130 may branch off from the connection part toward the battery packs 100.

With continued reference to FIG. 1, the battery structure 10 according to the embodiment of the present disclosure may further include a valve member 300 provided in the piping line 130 and configured to control and open or close the flow path in the piping line 130. More specifically, the valve member 300 may be opened or closed to adjust whether to supply the fire extinguishing fluid 210 in the fluid storage part 200 to the internal space of the casing part 120 and adjust a flow rate of the fire extinguishing fluid 210. For example, as illustrated in FIG. 1, the valve member 300 may be provided in a region in which the piping lines in the plurality of battery packs 100 begin to branch.

In addition, according to the first embodiment of the present disclosure, the plurality of battery packs 100 provided in the battery structure 10 may each further include a gas detection member 140 provided in the casing part 120 and configured to detect a gas in the casing part 120, and a control member 150 connected to the gas detection member 140 and configured to control and open or close the valve member 300 by receiving a signal from the gas detection member 140. The gas detection member 140 may detect a gas that increases in amount in the event of a fire caused by thermal runaway in the battery cell 110. For example, the battery cell 110 may further include an electrolyte 113, and the gas detection member 140 may detect a gas generated when the electrolyte 113 vaporizes.

Meanwhile, for example, the control member 150 may be a battery management system (BMS) member. The control member 150, which receives the signal from the gas detection member 140, may control and open or close the valve member 300 or control an opening degree of the valve member 300 by means of a computer member. More specifically, in case that a concentration of the gas in the casing part 120 of the battery pack 100 exceeds a predetermined value, the gas detection member 140 may transmit a signal to the control member 150, such that the control member 150 may control and open the valve member 300.

With continued reference to FIG. 1, according to the embodiment of the present disclosure, the plurality of battery packs 100 may each further include a level detection member 160 provided in the casing part 120 and configured to detect a level of the fire extinguishing fluid 210 in the casing part 120. In this case, the above-mentioned control member 150 may receive a signal, which is related to the level of the fire extinguishing fluid 210 in the casing part 120, from the level detection member 160. Therefore, according to the embodiment of the present disclosure, in case that the level of the fire extinguishing fluid 210 in the casing part 120 exceeds a predetermined value, the level detection member 160 may transmit a signal to the control member 150, and the control member 150 may control and close the valve member 300. Therefore, according to the present disclosure, the valve member 300 is closed, such that the supply of the fire extinguishing fluid 210 into the casing part 120 may be cut off.

Meanwhile, with reference to FIGS. 1 and 2, the plurality of battery packs 100 provided in the battery structure 10 according to the present disclosure may each further include a fracturable member 170 provided at one side of the piping line 130 and configured to close the piping line 130. However, the fracturable member 170 may be configured to be fractured at predetermined pressure or higher. According to the present disclosure, in case that the fracturable member 170 is fractured, the piping line 130 is opened, such that the fire extinguishing fluid 210 in the fluid storage part 200 may be introduced into the internal space of the casing part 120 through the piping line 130.

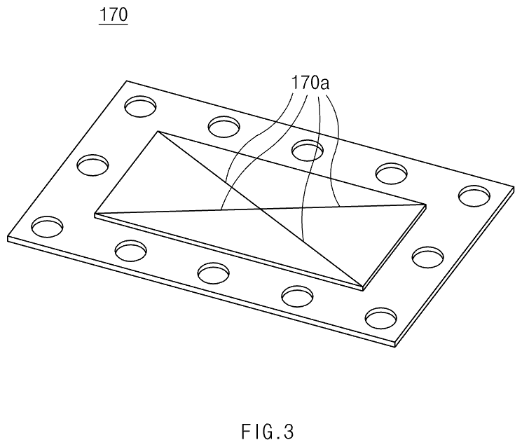

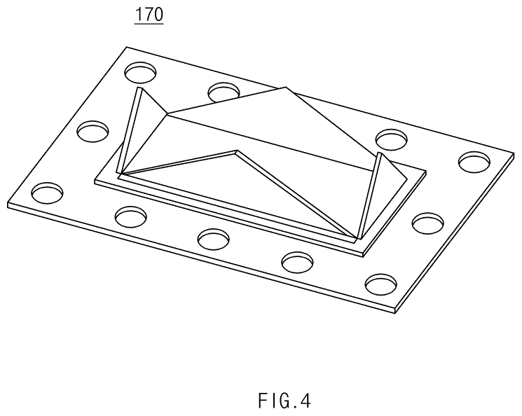

FIG. 3 is a view illustrating an example of a fracturable member provided in the battery structure of the present disclosure in a state made before the fracturable member is fractured, and FIG. 4 is a view illustrating an example of the fracturable member provided in the battery structure of the present disclosure in a state made after the fracturable member is fractured.

Meanwhile, according to the present disclosure, the fracturable member 170 may include notch regions 170a having a smaller thickness than the other portions of the fracturable member 170. Therefore, in case that pressure applied to the fracturable member 170 exceeds the predetermined value, the notch region 170a, which has relatively low durability, is fractured, such that the piping line 130 may be opened. For example, as illustrated in FIGS. 3 and 4, the notch regions 170a may define an ‘X’ shape.

Meanwhile, according to the embodiment of the present disclosure, the battery structure 10 may include all the valve member 300, the gas detection member 140, the control member 150, the level detection member 160, and the fracturable member 170. However, as illustrated in FIG. 2, according to another example of the present disclosure, the battery structure 10 may not include the valve member, the gas detection member, the control member, and the level detection member. More specifically, according to another embodiment of the present disclosure, only the fracturable member 170 may be provided in the battery pack 100 in the battery structure 10. In this case, even though the gas in the casing part 120 is not detected or the level of the fire extinguishing fluid in the casing part 120 is not detected, the fire extinguishing fluid 210 in the fluid storage part 200 may be supplied to the casing part 120 in the battery pack 100 in which thermal runaway occurs. That is, according to another embodiment of the present disclosure, in case that pressure in the casing part 120 exceeds a predetermined value in the event of thermal runaway in some of the plurality of battery packs 100, the fracturable member 170 is fractured, such that the fire extinguishing fluid 210 in the fluid storage part 200 may be supplied to the casing part 120 of the battery pack 100 through the piping line 130 in which the fractured fracturable member 170 is provided.

Meanwhile, according to the embodiment of the present disclosure and another embodiment of the present disclosure, the fluid storage part 200 may be provided above the plurality of battery packs 100 provided in the battery structure 10. In this case, the fire extinguishing fluid 210 in the fluid storage part 200 may be smoothly supplied to the battery pack 100 by gravity.

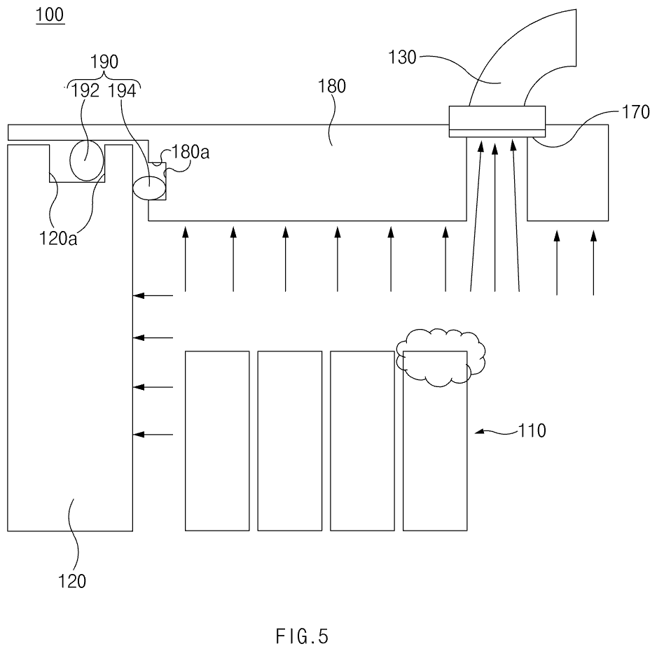

FIG. 5 is an enlarged schematic view illustrating a partial region of the battery pack in the battery structure according to the present disclosure.

With reference to FIG. 5, the plurality of battery packs 100 provided in the battery structure 10 according to the present disclosure may each further include a cover part 180 coupled to one side of the casing part 120. For example, FIG. 5 illustrates a state in which the cover part 180 is coupled to an upper side of the casing part 120.

In addition, the plurality of battery packs 100 may each further include sealing members 190 provided between the casing part 120 and the cover part 180. The sealing member 190 may be configured to improve sealability of the internal space of the casing part 120 and configured to prevent the fire extinguishing fluid 210 from leaking to the outside. For example, the sealing member 190 may be an O-ring.

Meanwhile, according to the present disclosure, the sealing members 190 may include first and second sealing members 192 and 194 provided separately from each other. In this case, according to the present disclosure, a direction in which the casing part 120 and the cover part 180 face each other with the first sealing member 192 interposed therebetween and a direction in which the casing part 120 and the cover part 180 face each other with the second sealing member 194 interposed therebetween may intersect each other. More particularly, the direction in which the casing part 120 and the cover part 180 face each other with the first sealing member 192 interposed therebetween and the direction in which the casing part 120 and the cover part 180 face each other with the second sealing member 194 interposed therebetween may perpendicularly intersect each other. For example, FIG. 5 illustrates a state in which the casing part 120 and the cover part 180 face each other in a vertical direction with the first sealing member 192 interposed therebetween, whereas the casing part 120 and the cover part 180 face each other in a horizontal direction with the second sealing member 194 interposed therebetween.

Meanwhile, the casing part 120 may have a first recessed region 120a having a recessed shape, and the cover part 180 may have a second recessed region 180a having a recessed shape. In this case, the first sealing member 192 may be seated in the first recessed region 120a, and the second sealing member 194 may be seated in the second recessed region 180a. In addition, for example, the cover part 180 may have a flat shape in a region in which the first sealing member 192 is in contact with the cover part 180, and the casing part 120 may have a flat shape in a region in which the second sealing member 194 is in contact with the casing part 120.

### Flight Vehicle

A flight vehicle 1 according to the present disclosure may include the battery structure 10. The description of the battery structure provided in the flight vehicle according to the present disclosure may be replaced with the above-mentioned description of the battery structure 10. The flight vehicle 1 may refer to an aerial mobility vehicle. For example, the flight vehicle 1 may be advanced air mobility (AAM).

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A battery structure comprising:
a plurality of battery packs; and
a fluid storage part disposed at one side of the plurality of battery packs and configured to store an electrically insulative fire extinguishing fluid,
wherein each of the plurality of battery packs comprises:
a plurality of battery cells comprising electrodes and separators;
a casing part defining an internal space configured to accommodate the battery cells; and
a piping line connected at one end to the casing part and at another end to the fluid storage part, the piping line having a flow path configured to deliver the fire extinguishing fluid to the casing part.

2. The battery structure of claim 1,
wherein at least some of piping lines of the plurality of battery packs are arranged in parallel with one another.

3. The battery structure of claim 1, further comprising:
a valve member disposed in the piping line and configured to open or close the flow path in the piping line,
wherein each of the plurality of battery packs further comprises:
a gas detection member disposed in the casing part and configured to detect a gas within the casing part; and
a control member operatively connected to the gas detection member and configured to operate the valve member in response to a signal from the gas detection member.

4. The battery structure of claim 3,
wherein each of the plurality of battery packs further comprise a level detection member disposed in the casing part and configured to detect a level of the fire extinguishing fluid in the casing part, and
wherein the control member is configured to receive a signal related to the level of the fire extinguishing fluid from the level detection member.

5. The battery structure of claim 3,
wherein the battery cell comprises an electrolyte, and
wherein the gas detection member is configured to detect a gas generated by vaporization of the electrolyte.

6. The battery structure of claim 1,
wherein each of the plurality of battery packs further comprise a fracturable member disposed at one side of the piping line, and
wherein the fracturable member is configured to close the piping line and to fracture when a predetermined pressure or higher is applied.

7. The battery structure of claim 6,
wherein the fracturable member comprises a notch region having a smaller thickness than other portions of the fracturable member.

8. The battery structure of claim 1,
wherein the fire extinguishing fluid includes or is composed of a fluoroketone-based material.

9. The battery structure of claim 1,
wherein the fluid storage part is disposed above the plurality of battery packs.

10. The battery structure of claim 1,
wherein each of the plurality of battery packs further comprises:
a cover part coupled to one side of the casing part; and
sealing members provided between the casing part and the cover part,
wherein the sealing members comprise first and second sealing members provided separately from each other, and
wherein a direction in which the casing part and the cover part face each other with the first sealing member interposed therebetween, and a direction in which the casing part and the cover part face each other with the second sealing member interposed therebetween, intersect each other.

11. The battery structure of claim 10,
wherein the casing part has a first recessed region having a recessed shape, the cover part has a second recessed region having a recessed shape, the first sealing member is seated in the first recessed region, and the second sealing member is seated in the second recessed region.

12. The battery structure of claim 11,
wherein the cover part has a flat surface in a region where the first sealing member is in contact with the cover part, and
wherein the casing part has a flat surface in a region where the second sealing member is in contact with the casing part.

13. A flight vehicle comprising the battery structure according to claim 1.

14. A method for extinguishing fire in a battery structure comprising a plurality of battery packs and a fluid storage part configured to store an electrically insulative fire extinguishing fluid, the method comprising:
detecting, by a gas detection member provided in a casing part of a battery pack, a gas generated in the casing part;
transmitting a detection signal from the gas detection member to a control member;
operating, by the control member, a valve member provided in a piping line connected between the fluid storage part and the battery pack; and
injecting the fire extinguishing fluid from the fluid storage part into the casing part of the battery pack through the piping line.

15. The method of claim 14,
wherein the gas detection member detects a gas generated by vaporization of an electrolyte included in a battery cell of the battery pack.

16. The method of claim 14,
wherein the control member further receives a signal related to a level of the fire extinguishing fluid detected by a level detection member provided in the casing part.

17. The method of claim 14,
wherein the fire extinguishing fluid includes a fluoroketone-based material that is electrically insulative and non-corrosive.
